(19) United States
(12) Patent Application Publication
(10) Pub. No.: US 2011/0295859 A1
(43) Pub. Date: Dec. 1, 2011

(54) Technique For Multi-Dimensionally Determining Strength Of An Item In A Weighted List Based On Tagging

(75) Inventors: Brian D. Friedman, Basking Ridge, NJ (US); Christophe Senot, Paris (FR); Michael J. Burns, Middletown, NJ (US)

(73) Assignee: Alcatel-Lucent USA Inc., Murray Hill, NJ (US)

(21) Appl. No.: 12/945,929

(22) Filed: Nov. 15, 2010

Related U.S. Application Data
(63) Continuation-in-part of application No. 12/788,442, filed on May 27, 2010.

(51) Int. Cl. G06F 17/30

(52) U.S. Cl. 707/748; 707/E17.001

(57) ABSTRACT

A weighted list may be visually shown on a website, e.g., as a tag cloud, object cloud, etc. The font size of each item in the weighted list may indicate its strength relative to the other items in the same. The strength of a weighted list item is determined based at least on multi-dimensional weights accorded to applications by users of a given tag to an object. For example, each multi-dimensional weight may be an aggregate of weight measures of two or more of quantity-based dimensions, time-based dimensions, social distance-based dimensions, semantic similarity dimensions, etc.

### CROSS-REFERENCE TO RELATED APPLICATIONS

This application is a continuation-in-part of U.S. patent application Ser. No. 12/788,442, filed on May 27, 2010, which is incorporated herein by reference in its entirety.

### FIELD OF THE INVENTION

The invention relates to a data processing technique and, more particularly, to a technique for providing a weighted list (e.g., a tag cloud, an object cloud, etc.) resulting from tag applications.

### BACKGROUND OF THE INVENTION

This section introduces aspects that may help facilitate a better understanding of the invention. Accordingly, the statements of this section are to be read in this light and are not to be understood as admissions about what is prior art or what is not prior art.

Many web services allow a user to apply a tag to an object on their web page as a keyword, category label or metadata to facilitate, for example, a subsequent search for the object by the user or others. For example, upon browsing information about a person on some social networking websites, users may apply one or more tags to the object person. For instance, the object person may be tagged with a label “Javascript” by users/taggers who may think the person is an expert in javascript programming language or related to javascript in whatever ways. The object person may also be tagged with a second label “Sense of Humor” by the same or different taggers who may think the person has a sense of humor, or is related to a sense of humor in whatever ways.

A weighted list, referred to as a “tag cloud,” which contains tag items representing the Javascript and Sense of Humor tags, and other tags applied by taggers to the object person, may be formed and visually shown on the website, with the tag items indicating their relative strengths. The Javascript tag item may be shown stronger than the Sense of Humor tag item if the number of taggers applying the Javascript tag is greater than that applying the Sense of Humor tag to the same object person. For example, a relatively strong tag item may be shown in a tag cloud in a relatively large font size.

Another weighted list, referred to as an “object cloud,” may also be formed, which contains items representing different objects to which the same tag, e.g., the Javascript tag, has been applied. The more times the tag has been applied to an object represented by an object item, the stronger the object item. A relatively strong object item may also be shown in a relatively large font size.

### BRIEF SUMMARY

The invention was born from the belief that increasing the accuracy of the strength of items in weighted lists (e.g., tag clouds, object clouds and other clouds) provided on a website garners credibility thereof, which is conducive to increasing traffic to the website. The strength of an item in a weighted list is determined based on applications of a given tag to an object, each of which traditionally is treated equally and accorded the same weight. However, in accordance with an embodiment of the invention, an application of the given tag to the object may be accorded a multi-dimensional weight different than another application, thereby improving an accuracy of the item strength determination.

Thus, in accordance with an embodiment of the invention, after an entry by a user of a given tag for an object is received, weight measures associated with the entry by the user are determined. A strength measure associated with the given tag for the object is then determined based at least on values of the weight measures. A weighted list is realizable in which an item indicates the strength measure. In some embodiments, the weight measures are of two or more of quantity-based dimensions, time-based dimensions, social distance-based dimensions, semantic similarity dimensions, etc.

### BRIEF DESCRIPTION OF THE DRAWINGS

FIG. 1 is a block diagram of a server according to an embodiment of the invention;

FIG. 2 illustrates a first web page provided by the server;

FIG. 3 illustrates a second web page provided by the server;

FIG. 4 illustrates a tag cloud provided by the server in one embodiment;

FIG. 5 is a flow chart depicting a first routine executed in the server;

FIG. 6 illustrates a second routine executed in the server;

FIG. 7 illustrates fields of a record kept in a database in the server;

FIG. 8 is a diagram depicting a relationship between taggers applying a given tag to an object in one embodiment;

FIG. 9 illustrates an object cloud provided by the server in one embodiment;

FIG. 10 illustrates a database containing tag application records having different fields m one embodiment;

FIG. 11 is a flow chart depicting a routine for determining a factor in assessing a weight of a time-based dimension in one embodiment;

FIG. 12 is a flow chart depicting a routine for determining a factor in assessing a weight of a social distance-based dimension in one embodiment;

FIG. 13 is a table containing user profiles in one embodiment;

FIG. 14 is a flow chart depicting a routine for determining a weight of a social distance-based dimension in one embodiment;

FIG. 15 is a table containing data concerning tags and their semantically similar tags in one embodiment; and

FIG. 16 illustrates a routine for determining strength of an item in a weighted list in one embodiment.

### DETAILED DESCRIPTION

Allowing tagging of an object by applying thereto a descriptor, e.g., a short phrase, keyword, category label, metadata, etc., has become a common feature on a website. The tags applied by visitors of the website help identify the object and build a collective knowledge base about the object within a web-based application. For example, on some social networking websites, member A may apply to member B the tag “Javascript” to indicate that member B is an expert in that particular computer language. The more members who tag member B with “Javascript,” the more likely it is, and more confident arc the other members, that member B is indeed a javascript expert.

FIG. 1 illustrates a server 100 embodying the principles of the invention which may he used to provide a web service, e.g., a social-network-type service. In one embodiment, server 100 is an Apache HTTP server (also known as “Apache”) based system, whose software is stored in memory 103. As is well known, Apache affords support for such server side scripting languages as PHP hypertext preprocessor language (“PHP” in short), and such database servers as MySQL. For example, using PHP in this instance, processor 105 is programmed to provide tagging capabilities, described below, on web pages as part of the web service.

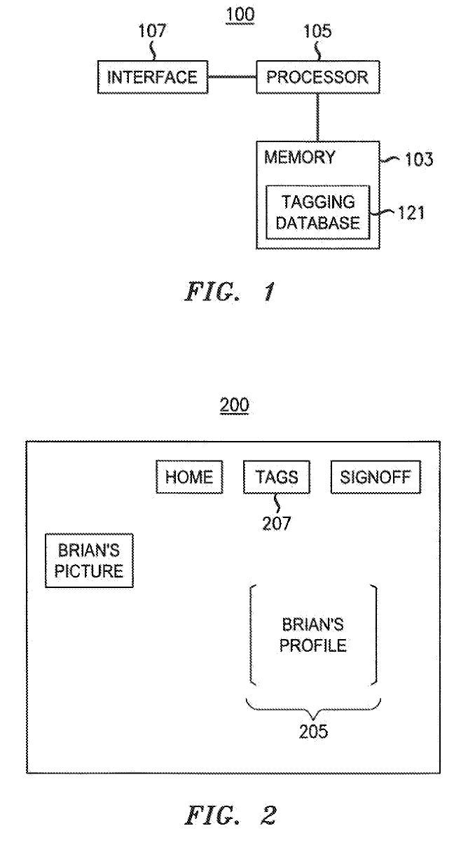

FIG. 2 illustrates one such web page 200, which is accessible to users through interface 107. For example, interface 107 may allow hypertext transfer protocol (HTTP) connections by users to server 100 via the Internet or an intranet. By way of example, but not limitation, web page 200 includes a profile of a person named. “Brian,” denoted 205, and options including a Tags option denoted 207. Selection of Tags option 207 allows a user to apply a tag descriptive of an object on web page 200, which in this instance is the person as profiled.

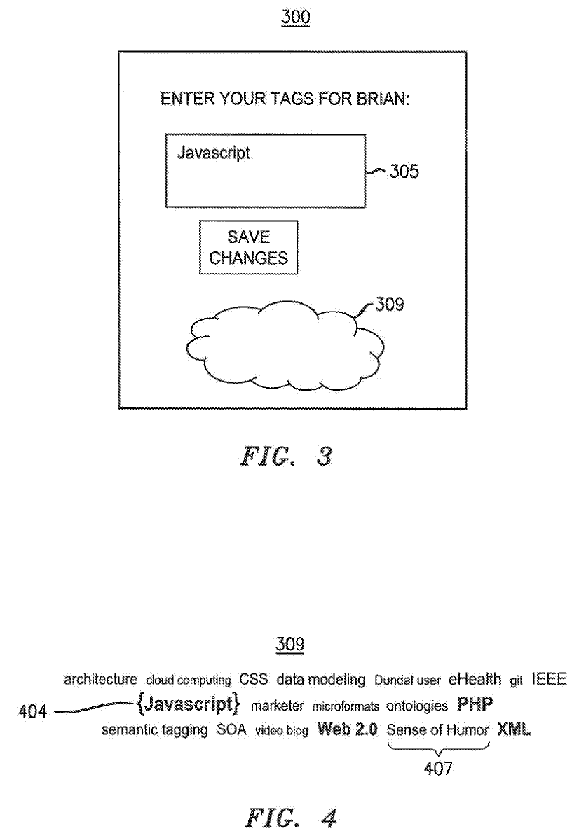

FIG. 3 illustrates web page 300 where the user is prompted to enter the descriptive tag after option 207 is selected. In response, the user in this instance enters in field 305 a word “Javascript” as a tag descriptive of the object person. It should be noted at this point that a person skilled in the art will appreciate that a tag may:not be limited to textual form, e.g., a word or short phrase. It may be in graphical form, e.g., an icon; in audio form, e.g., a sound recording; or in any other perceptible form or a combination thereof.

Processor 105 then determines the strength of a Javascript tag item in a weighted list, e.g., a tag cloud after the user's Javascript tag entry, and causes the tag cloud, denoted 309, to be displayed. FIG. 4 illustrates tag cloud 309, which contains Javascipt tag item 404 representing the Javascript tag and other tag items representing other tags associated with the object person. The tag items in cloud 309 indicate their respective strengths determined by processor 105. These tag items in this instance comprise hypertext markup language (HTML) elements whose display styles may be defined by a cascading style sheet (CSS) in a file (not shown) stored in memory 103.

As illustrated in FIG. 4, tag item 404 indicates its strength by its font size, relative to those of the other tag items (e.g., Sense of Humor tag item 407) in cloud 309. In this illustrative example, the stronger processor 105 determines a tag item to be, the larger font size the associated tag item shown in a tag cloud. It will be appreciated that the strengths of the tag items shown in a tag cloud may also be distinguished, e.g., by their colors, hues, shades, shadows, fonts or other visual, audio or perceptible means, or a combination thereof.

Traditionally, each application of a given tag to a particular object is treated equally and accorded the same weight. In that case, the strength of the tag item representing the given tag simply varies with the number of times the given tag was applied to the particular object. However, in accordance with an embodiment of the invention, an application of a given tag to a particular object may be accorded a different weight than another application. For instance, the actual weight accorded to an application of a given tag may depend on certain qualities of the tagger applying the given tag.

To help appreciate the invention, let's consider a simple scenario where, say, seven people applied a Javascript tag to person X, and three people applied the same Javascript tag to person Y. Now assume person Z has been tagged with “Javascript” by X, Y, and Z himself. According to the traditional method, the strength of the tag item representing the Javascript tag for person Z in that scenario would be 3 because of the three respective applications by X, Y and Z of the Javascript tag to person Z, which are treated equally. However, in accordance with an embodiment of the invention, the three applications of the Javascript tag to Z are not treated equally. Rather, they are accorded different weights associated with the taggers X, Y, and Z, respectively.

In one embodiment, the weight associated with a tagger other than the object person is 1 plus the number of times that the tagger has been tagged with a given tag, i.e., the Javascript tag in this instance. On the other hand, the weight associated with the tagger who is also the object person is always 1. The strength of the tag item representing the given tag for the object person in this embodiment equals the sum of the weights accorded to the applications of the tag, which are associated with the taggers, respectively. Thus, in the above scenario, the application by X of the Javascript tag to the object person Z is accorded the weight associated with X, which is 1+7=8. The application by Y of the Javascript tag to Z is accorded the weight associated with Y, which is 1+3=4. The application of Z of the Javascript tag to Z himself is accorded 1. Thus, the strength of the Javascript tag item for Z in that scenario is 8+4+1=13.

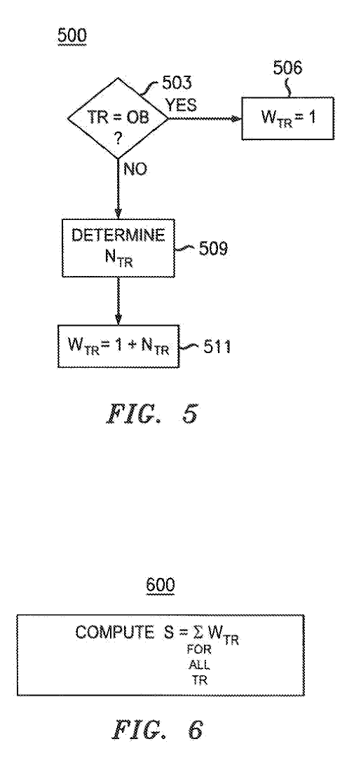

The invention was born from the belief that increasing the accuracy of the strength of items in weighted lists (e.g., tag clouds, object clouds and other clouds) provided on a website garners credibility thereof, which is conducive to increasing traffic to the website. In accordance with an embodiment of the invention, the more times a given tag has been applied to a person, the more weight that person carries when applying that tag to an object, as demonstrated in the above-described scenario, thereby improving the accuracy of the strength of the item representing the tag for the object. To that end, processor 105 in one embodiment determines a weight (W_{TR}) associated with each tagger TR applying the tag T to the object person OB, in accordance with routine 500 in FIG. 5. Instructed by routine 500, processor 105 at step 503 determines whether the tagger TR happens to be the object person OB, i.e., TR=OB. If so, W_{TR}=1, as indicated at step 506. Otherwise if TR≠OB, processor at step 509 determines the number of times (N_{TR}) tag T was applied to TR, and at step 511 determines W_{TR}=1+N_{TR}.

FIG. 6 illustrates a routine, denoted 600, for processor 105 to compute the strength (S) of an item in a weighted list. In one embodiment, the weighted list is a tag cloud, and the item represents T for OB. As illustrated in FIG. 6, S equals the sum of the respective weights (W_{TR}) associated with all taggers applying T to OB.

In implementation, tagging database 121 is maintained in memory 103 in FIG. 1, which can be queried using a MySQL server (not shown) in server 100. Database 121 contains each record of an application by a tagger TR of a tag T to an object OB. FIG. 7 illustrates fields of the record which are denoted 703, 705 and 707, respectively. Specifically, field 703 of the record is referred to as a “TRID” field, which contains an identification (ID) number identifying the tagger TR. Field 705 is referred to as an “OBID” field, which contains an ID number identifying the object OB. Field 707 is referred to as a “TID” field, which contains an ID number identifying the tag T. In this particular implementation, a first table (not shown) is maintained in memory 103 for translating a TRID number or OBID number to an identity of a user of the subject service. A second table (not shown) is also maintained for translating a TID number to an actual tag, e.g., “Javascript.” Continuing the above-described scenario, when database 121 is queried using the MySQL server for records having OBID=X's ID, and TID=the ID of “Javascript,” the server returns seven records, indicating that seven taggers identified by the TRIDs in the respective records have applied the “Javascript” tag to X. Similarly, when database 121 is queried for records having OBID=Y's ID, and TID=the ID of “Javascript,” the server returns three records. Thus, by querying database 121, processor 105 can determine the N_{TR} associated with X and Y by registering the respective numbers of records returned.

After processor 105 executes routine 600 to determine that a tag item representing a given tag for an object possesses a particular S, processor 105 prepares to display the tag item in an appropriate font size reflecting its particular S. To that end, processor 105 compares the particular S with the range of S of the tag items in tag cloud 309 previously determined. Processor 105 normalizes (“maps”) the strength S of each of the items to be displayed based on the minimum and maximum font sizes that would be reasonable to use, and sets the font size of each item accordingly. For example, if the minimum font size is to be 10 and the maximum font size is to be 36, then the range of strengths may be normalized (mapped) such that all items are displayed with font sizes between 10 and 36. In any event, once processor 105 determines the appropriate font sizes for all of the tag items in cloud 309, processor 105 sets the respective font sizes of the tag items in memory 103 accordingly, thereby realizing representations of their relative strengths in cloud 309.

In the above embodiment, the strength of a tag item representing a given tag is determined based on the, weight associated with each tagger applying the given tag to the object, where the weight is computed based on the number of times the same given tag was previously applied to the tagger (N_{TR}). It is anticipated that, based on the disclosure heretofore, a person skilled in the art will readily improve the accuracy of the tag item strength determination by taking into consideration not only the N_{TR} of the “first level” taggers directly applying the given tag to the object, but also the N_{TR} of the “second level” taggers applying the given tag to the first level taggers, the N_{TR} of the “third level” taggers applying the given tag to the second level taggers . . . , and so on and so forth. Of course, the number of levels in one such recursive process is limited by the computational expensiveness of the process which entails recursive database queries for each tagger at each level, and for each tag in the tag cloud.

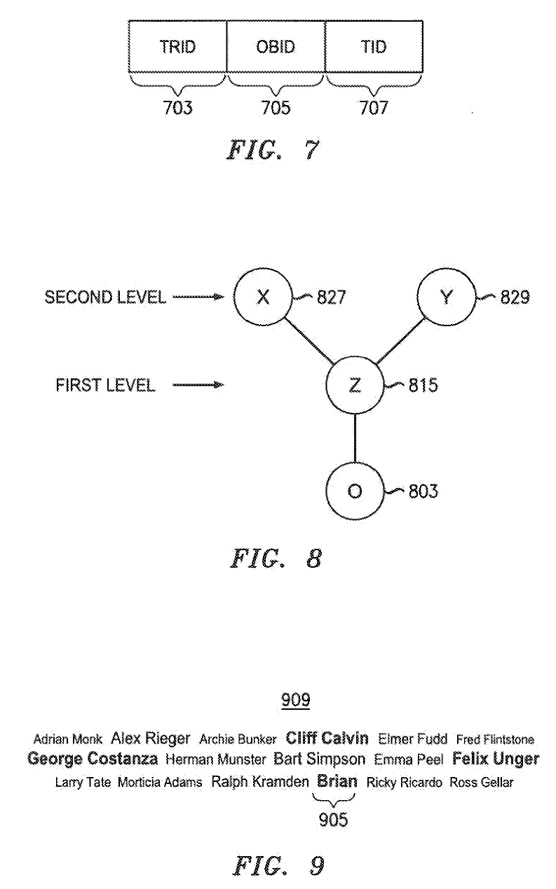

An embodiment will now be described where a determination of the strength of a tag item representing a given tag based not only on the qualities of the first level taggers applying the given tag to an object, but also those of the second level taggers applying the given tag to the first level taggers (i.e., a two-level determination). This embodiment furthers the above-described scenario by now assuming Z has applied the Javascript tag to an object O, and for the sake of simplicity, Z is the only tagger who has applied such a tag to O. FIG. 8 is a tree diagram which illustrates the relationship of O, represented by root node 803, with the, first level tagger Z, represented by first-level node 815, and second level taggers X and Y, represented by second-level nodes 827 and 829, respectively. As mentioned before, taggers X and Y previously applied the same Javascript tag to Z. To make the two level determination of the strength of the Javascript tag item associated with O, processor 105 queries database 121 using the MySQL server for any records having OBID=O's ID and TID=the ID of “Javascript.” In this instance, the MySQL server returns a single record having TRID=Z's ID. Having learned that Z is the only first-level tagger applying the Javascript tag to O, processor 105 queries database 121 for any records having OBID=Z's ID and TID=the ID of “Javascript.” In this instance, the MySQL server returns three records having the respective TRIDs=X's ID, Y's ID and Z's ID, indicating that N_{TR=Z}=3. Having learned from the returned records that X and Y, different from Z, are the second level taggers, processor 105 further queries database 121 for any records having OBID=X's ID and TID=the ID of “Javascript.” In this instance, the MySQL server returns seven records, indicating that N_{TR=X}=7. Processor 105 then queries database 121 for any records having OBID=Y's ID, and TID=the ID of “Javascript.” In this instance, the MySQL server returns three records, indicating that N_{TR=Y}=3. In this two-level determination, the weight accorded to the application by Z of the Javascript tag to O is 1+N_{TR=Z}+N_{TR=X}+N_{TR=Y}=1+3+7+3=14. Since in this embodiment Z is the only tagger applying the Javascript tag to O, the strength of the tag item representing the Javascript tag for O is the same as the weight associated with Z, which equals 14, compared with that determined using the traditional method which equals 1.

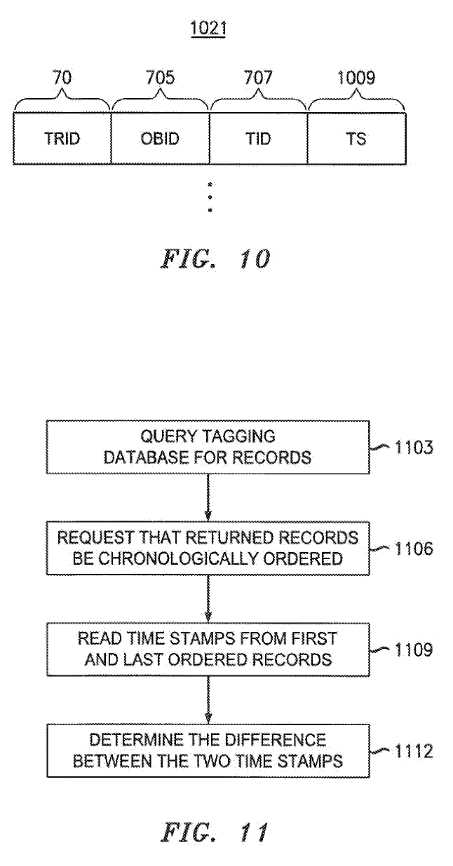

Weighted lists other than a tag cloud which contain items indicating their relative strengths are within the spirit and scope of the invention. In one embodiment, a weighted list is provided as an object cloud containing items representing objects to which the same tag, e.g., the Javascript tag, has been applied. FIG. 9 illustrates one such object cloud 909 on a web page, which may be accessed, e.g., by selecting Javascript tag item 404, which in this instance comprises a hyperlink to such a web page. This web page may also be accessed by searching on the tag “Javascript” on the associated website. In FIG. 9 object cloud 909 contains items representing objects, e.g., item 905 representing Brian, to which the Javascript tag has been applied. Object item 905 in this instance is in textual form and indicates its strength S computed by processor 105 according to routine 600, relative to the strengths of other object items in cloud 909 by its relative font size.

To further increase the accuracy of a strength determination for an item in a weighted list, in some embodiments the weight carried by an application of a given tag affecting the strength of the item is determined by factoring in weight measures of one or more “dimensions.” By way of example, but not limitation, these dimensions may be “quantity-based” dimensions (Q-dimensions), “time-based” dimensions (T-dimensions), “social distance-based” dimensions (SD-dimensions), and “semantic similarity” dimensions (SS-dimensions) individually or in any combinations thereof. In general, weight measures of different dimensions may be aggregated to arrive at a multi-dimensional weight for determination of the strength of the item, referred to as a “generalized” item-strength (S_{G}) determination. To perform the generalized item-strength determination, processor 105 may be programmed to aggregate one or more weight measures of one or more dimensions which, for example, may be one or more Q-dimensional weight measures, one or more T-dimensional weight measures, one or more SD-dimensional weight measures, and/or one or more SS-dimensional weight measures.

A Q-dimensional weight measure generally is based on the number of times a given tag to an object in question has been applied. It should be noted at this point that the item-strength determination in the above-described embodiment as illustrated in FIGS. 5 and 6, which is based on the number of times each tagger TR was tagged with a given tag currently applied by the tagger (N_{TR}), is but one particular example of the generalized item-strength determination. That particular item-strength determination involves summing for all TRs weight measures (W_{TR}=1+N_{TR}) of only one dimension, which is a Q-dimension since W_{TR} is a weight measure concerning the number of times a given tag has been applied.

A second Q-dimensional weight measure (W_{Q2}) may be based on the number of times that the given tag has been applied to any objects in the system (N_{Q2}). The greater N_{Q2} is, the more likely that the given tag is overused, thereby becoming less relevant. In accordance with an embodiment of the invention, W_{Q2} varies inversely with N_{Q2}. Their inverse relation may be expressed in a stepwise fashion. In one embodiment, W_{Q2}=w when N_{Q2}<n, and W_{Q2}=0 when N_{Q2} n, where w is a predetermined weight value, and n represents a threshold which is a predetermined integer. Where, for example, the given tag is, say, “Javascript,” N_{Q2} is obtained by processor 105 counting the number of records returned after tagging database 121 is queried for records having TID=the ID of “Javascript.” Such a TID may be looked up from the aforementioned second table used for translating a tag, e.g., “Javascript” to the corresponding TID, and vice versa.

A third Q-dimensional weight measure (W_{Q3}) may be based on the number of times that a tagger has applied the same tag to other objects (N_{Q3}) as to the object in question. The greater N_{Q3}, the number of times a tagger has applied the same tag, the heavier the weight W_{Q3} accorded to the tagger's current application of that tag to an object. In general, W_{Q3} increases with N_{Q3}. In one embodiment, W_{Q3}=N_{Q3}. Where, for example, the given tag is, say, “Javascript,” N_{Q3} is obtained by processor 105 counting the number of records returned after it queries tagging database 121 for records having TRID=the ID of the tagger, and TID=the ID of “Javascript.” Such a TRID may be looked up from the aforementioned first table used for translating an identity of a user of the subject service, e.g., a tagger, to the corresponding TRID, and vice versa.

A T-dimensional weight measure generally takes into account the amount of time elapsed since a given tag was applied. A first T-dimensional weight measure (W_{T1}) may be based on such an amount of time (T_{T1}). In accordance with an embodiment, the longer T_{T1} since an application of a given tag to an object is, the lesser weight W_{T1} accorded to that tag application. Thus, W_{T1} varies inversely with T_{T1}. Their inverse relation may be expressed in intervals. In one embodiment, W_{T1}=(1/k)w₀ if (k−1)τ₁≦T_{T1}≦kτ₁, where k represents an integer index greater than zero, w₀ represents the weight initially accorded to the application of the given tag to the object, and τ₁ represents a predetermined time period. To determine a T-dimensional measure, the time at which a tag was applied to an object also needs to be recorded in database 121. The resulting T-dimensionally enhanced tagging database, denoted 1021 in FIG. 10, contains records each not only having TRID field 703, OBID field 705 and TID field 707 as in database 121, but also TS field 1009 containing a time stamp indicative of the time at which the corresponding tag was applied. T_{T1} may be determined by processor 105 querying tagging database 1021 for records having OBID=the ID of the object, and TID=the ID of a given tag, e.g., “Javascript.” Each returned record represents an application of the same given tag to the identified object. For each record, processor 105 calculates the difference between the current time and the time in TS field 1009 in the record, resulting in T_{T1}, the amount of elapsed time since the tag application of record.

A second T-dimensional weight measure (W_{T2}) may be based on the length of time between the first application and the most recent (e.g., current) application of a given tag (T_{T2}). In accordance with an embodiment of the invention, the longer T_{T2}, the length of time that the given tag has been associated with the object, the more relevant that tag is likely to be, and thus the heavier the corresponding W_{T2}. In general, W_{T2} increases with T_{T2}. In one embodiment, W_{T2}=kw₀ if (k−1)τ₂≦T_{T2}≦τ₂, where k represents an integer index greater than zero, w₀ represents the weight initially accorded to the application of the given tag to the object, and τ₂ represents a predetermined time period.

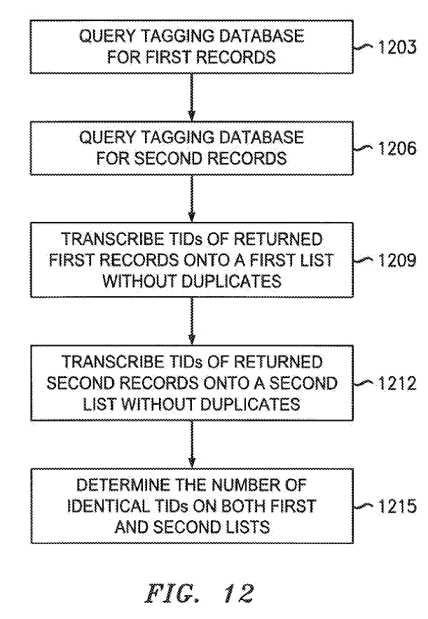

Referring to FIG. 11 illustrating a routine, which may be stored in memory 103, for determining T_{T2,} processor 105 at step 1103 queries tagging database 1021 for records which have OBID=the ID of the object, and TID=the ID of a given tag, e.g., “Javascript.” In addition, processor 105 at step 1106 requests that the returned records, each representing an application of the same given tag to the identified object, be arranged in chronological order based on the time stamp in their TS field 1009. Processor 105 at step 1109 reads the two time stamps from the respective TS fields of the first and last ones of the chronologically ordered records. At step 1112, processor 105 determines the difference between such two time stamps, resulting in T_{T2}.

An SD-dimensional weight measure generally takes into account how closely “related” the tagger is to the object being tagged or to the tag itself. A first SD-dimensional measure (W_{SD1}) may be based on the number of tags shared between the tagger and the object being tagged (R_{SD1}). In accordance with an embodiment of the invention, the greater the number R_{SD1} is, the heavier W_{SD1} accorded to the current tag application by the tagger to the object. In general. W_{SD1} increases with R_{SD1}. In one embodiment, W_{SD1}=R_{SD1}. Referring to FIG. 12 illustrating a routine, which may be stored in memory 105, for determining R_{SD1}, processor 105 at step 1203 queries tagging database 121 (or 1021) for first records having an OBID in field 705=the ID of the tagger in question. At step 1206, processor 105 queries tagging database 121 (or 1021) for second records having an OBID in field 705=the ID of the object in question. At step 1209, processor 105 transcribes the TIDs in fields 707 of the returned first records onto a first list without any duplicates. At step 1212, processor 105 transcribes the TIDs in fields 707 of the returned second records onto a second list without any duplicates. At step 1215, processor 105 determines the number of identical TIDs on both first and second lists, resulting in R_{SD1}.

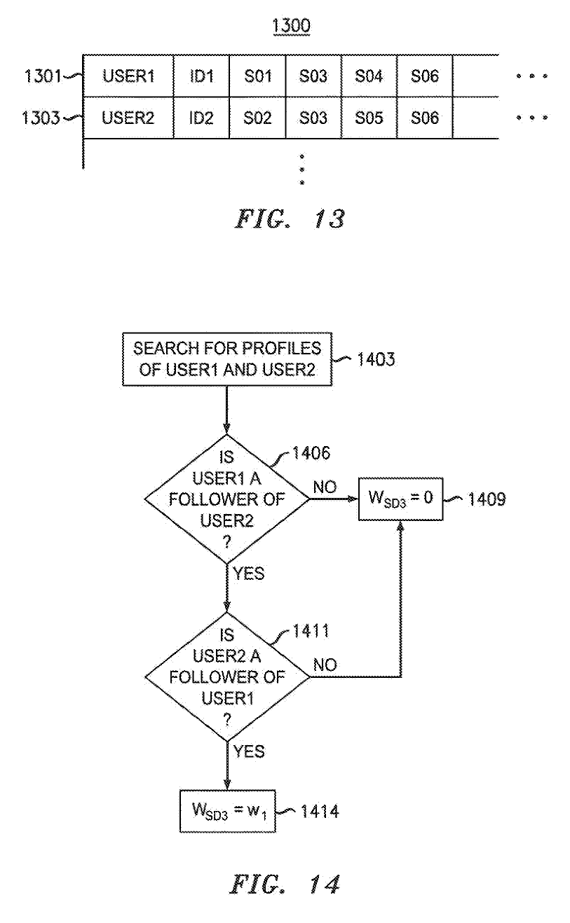

A second SD-dimensional weight measure (W_{SD2}) may be based on the number of social objects that the tagger and the object being tagged have in common (R_{SD2}). By way of example, but not limitation, the social objects here may include memberships of professional organizations, memberships of social clubs, hobbies, interests, professional and academic achievements and recognitions, school and company affiliations, etc. In accordance with an embodiment of the invention, the greater the number R_{SD2} is, the heavier W_{SD2} accorded to the current tag application by the tagger to the object. In general, W_{SD2} increases with R_{SD2}. In one embodiment, W_{SD2}=R_{SD2}. To determine R_{SD2}, profiles of users of the subject service need to be established. To that end, in one embodiment the aforementioned first table is enhanced to include not only an ID number identifying a user, but also codes indicating any of his/her memberships of professional organizations, memberships of social clubs, interests, hobbies, professional and academic achievements and recognitions, school and company affiliations, and other social objects, resulting in table 1300 in FIG. 13. Such user profiles in table 1300 may have been established when the users first joined the subject service, e.g., by the users' answering a series of preset questions and/or by other information entered by the user or about the user into the system after the user first joined the service.

As shown in FIG. 13, table 1300 includes, among others, profiles 1301 and 1303 of user1 and user2, respectively. Profile 1301 in this instance contains ID1, the ID assigned to user1, followed by codes SO1, SO3, SO4, SO6, etc., indicating the respective social objects associated with user1. Profile 1303 in this instance contains ID2, the ID assigned to user2, followed by codes SO2, SO3, SO5, SO6, etc., indicating the respective social objects associated with user2. In this example, user1 and user2 have two social objects in common, which are coded SO3 and SO6. Thus, for instance, when user1 applies a selected tag (e.g., “Javascript”) to user2, realizing TRID=ID1 and OBID=ID2 in this instance, processor 105 searches for the profiles of user1 and user2 identified by ID1 and ID2, respectively. Processor 105 then determines from profile 1301 of user1 and profile 1303 of user2 that user1 and user2 have two social objects in common. As a result, processor 105 accords W_{SD2}=R_{SD2}=2 to the application by user1 of the selected tag to user2.

A third SD-dimensional weight measure (W_{SD3}) may be based on whether the tagger and the object being tagged are “buddies” or have a notable relationship with each other. In the context of a social networking service, one such notable relationship may be that the tagger and the object are “followers” of each other. In one embodiment each profile of a user in table 1300 is enhanced to allow inclusion of IDs of the users whom that user is following. Referring to FIG. 14, when, for instance, user1 applies a selected tag (e.g., “Javascript”) to user2, realizing TRID=ID1 and OBID=ID2 in this instance, processor 105 at step 1403 searches table 1300 for the profiles of user1 and user2 identified by ID1 and ID2, respectively. Processor 105 at step 1406 determines whether user1 is a follower of user2 by checking the profile of user1 for any listing of ID2 as an ID of a user being followed by user1. If not, processor 105 at step 1409 sets W_{SD3}=0. Otherwise if user1 is a follower of user2, processor 105 proceeds to step 1411 where processor 105 determines whether user2 is a follower of user1 by checking the profile of user2 for any listing of ID1 as an ID of a user being followed by user2. If not, processor 105 returns to step 1409. Otherwise if user2 is also a follower of user1, processor 105 at step 1414 sets W_{SD3}=w₁, where w₁ represents a predetermined weight value.

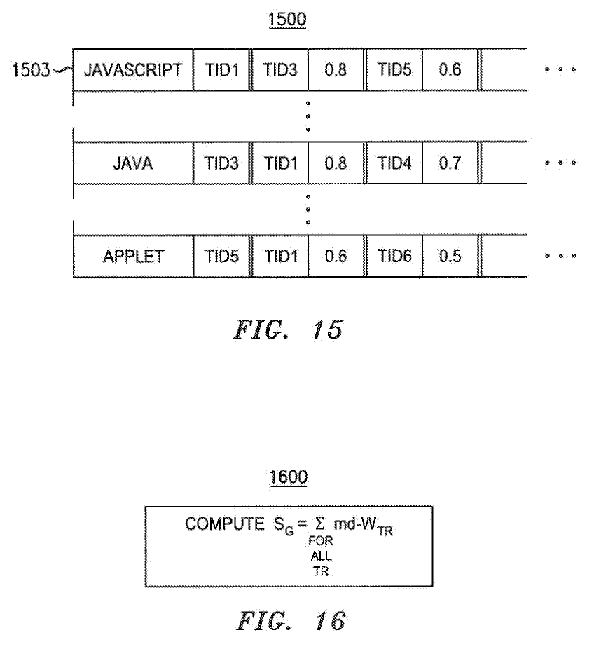

An SS-dimensional weight measure generally takes into account the number and/or degree of similarity of tags semantically related to the tag being applied by a tagger. A first SS-dimensional weight measure (W_{SS1}) may be based on the number (N_{SS1}) and degree of similarity (D_{SS1}) of semantically related tags that have been applied to the tagger. In one embodiment, the greater N_{SS1} and D_{SS1} are, the heavier W_{SS1}. In other words, W_{SS1} increases with N_{SS1} and D_{SS1}. To determine W_{SS1}, in one embodiment the aforementioned second table for translating a tag to the corresponding TID number is enhanced to provide a tag “thesaurus,” resulting in thesaurus table 1500 in FIG. 15. As shown in FIG. 15, table 1500 comprises rows corresponding to various tags. For example, row 1503 which corresponds to the tag “Javascript” contains TID1 identifying the tag, and additional TIDs identifying semantically related tags. In this example, these additional TIDs include TID3 and TID5 identifying “Java” and “Applet” tags, respectively, which are semantically related to the “Javascript” tag. Further, in this example the TID of each semantically related tag is associated with a degree of similarity index (DSI) which indicates how semantically similar the associated tag is to the tag in question (i.e., Javascript in this instance). In this illustrative embodiment, a DSI ranges from zero to one, with one being the most semantically similar. As illustrated in table 1500, TID3 identifying the “Java” tag in this instance is rated with a DSI=0.8, and TID5 identifying the “Applet” tag rated with DSI=0.6 with respect to the “Javascript” tag.

To demonstrate the determination of W_{SS1}, let's say tagger X has applied a “Javascript” tag to an object. In response to such a tag application, processor 105 looks up the “Javascript” tag in table 1500, and reads from row 1503 the TIDs identifying the semantically related tags (i.e., TID3 and TID5 in this instance) and the associated DSIs (i.e., 0.8 and 0.6 in this instance). Processor 105 queries tagging database 121 (or 1021) for any records having OBID=the ID of tagger X, and TID=TID3 or TID5. In the case where no such record is returned, i.e., tagger X having never been tagged with “Java” or “Applet,” processor 105 sets W_{SS1}=0. Otherwise, processor 105 increases W_{SS1}, initially set to be zero, by 0.8 for each returned record having TID=TID3, and by 0.6 for each returned record having TID=TID5.

A second SS-dimensional weight measure (W_{SS2}) may be based on the number (N_{SS2}) and degree of similarity (D_{SS2}) of semantically related tags that have been applied by the tagger to other objects. In one embodiment, the greater N_{SS2} and D_{SS2} are, the heavier W_{SS2}. In other words, W_{SS2} increases with N_{SS2} and D_{SS2}. To demonstrate the determination of W_{SS2}, let's continue to use the above example where tagger X has applied a “Javascript” tag to an object. In response such a tag application, processor 105 looks up the “Javascript” tag in table 1500, and reads from row 1503 the TIDs identifying the semantically related tags (i.e., TID3 and TID5 in this instance) and the associated DSIs (i.e., 0.8 and 0.6 in this instance). Processor 105 queries tagging database 121 (or 1021) for any records having TRID=the ID of tagger X, and TID=TID3 or TID5. In the case where no such record is returned, i.e., tagger X having never been tagged with “Java” or “Applet,” processor 105 sets W_{SS2}=0. Otherwise, processor 105 increases W_{SS2}, initially set to be zero, by 0.8 for each returned record having TID=TID3, and by 0.6 for each returned record having TID=TID5.

Processor 105 may determine the aforementioned strength S_{G} of a given item in a weighted list based on a multi-dimensional weight (md-W_{TR}) accorded to an application by each tagger TR of a given tag to the object in question. In one embodiment, md-W_{TR} may be realized by aggregating weight measures of different dimensions accorded to TR's tag application, which may be expressed as follows:

md-W_{TR}−Agg(W_{d1}(r_{d1}), W_{d2}(r_{d2}), . . . W_{dn}(r_{dn}), . . . , W_{dN}(r_{dN})),

where W_{dn}(1≦n≦N) generically represents, for example, one of the above described Q-, T-, SD-, SS-dimensional weight measures, and is a function of r_{dn} representing a relevance (or importance) factor, which influences the associated weight measure W_{dn}. In one embodiment, W_{dn}(r_{dn})=W_{dn}r_{dn} and r_{dn} ranges from zero to one, with one being the most relevant (or important). In the present illustrative embodiment, the relevance of the weight measure of each dimension, i.e., the value of r_{dn} for each corresponding W_{dn}, is determined by an administrator of the subject service. In another embodiment, users of the subject service may be given control over the r_{dn} factor. In that embodiment, a user may be allowed to enter an r_{dn} value for each corresponding W_{dn} depending on how relevant the user thinks the weight measure of a particular dimension is to the user.

When performing the “Agg” function in the above expression, processor 105 may determine a sum in one embodiment, the minimum in another embodiment, the maximum in yet another embodiment, or an average in still another embodiment of the individual weight measures (W_{dn}). It will be appreciated that a person skilled in the art may devise other ways to aggregate W_{dn} to realize the Agg function, depending on the specific requirements in the design of the subject service.

FIG. 16 illustrates a routine, denoted 1600, for processor 105 to compute the strength S_{G} of an item in a weighted list. As illustrated in FIG. 16, S_{G} equals the sum of the respective multi-dimensional weights (md-W_{TR}) associated with all taggers (i.e., all TRs) applying the given tag T to the object in question.

The foregoing merely illustrates the principles of the invention. It will thus be appreciated that those skilled in the art will be able to devise numerous arrangements which embody the principles of the invention and are thus within its spirit and scope.

For example, it will be appreciated that a person skilled in the art may devise weight measures of different dimensions, e.g., based on a combination of the dimensions as disclosed, thereby yielding such dimensions as “semantic similarity/time” dimensions, “social distance/quantity” dimensions, etc.

Further, it will be appreciated that a person skilled in the art may devise weight measures having dimensions of the types other than those described herein.

In addition, it will be appreciated that in determining an SS-dimensional weight measure as disclosed, a person skilled in the art may choose to factor in the number of tags semantically related to the tag being applied by a tagger (N_{SS}), without regard to the degree of their similarity (D_{SS}). In that case, the SS-dimensional weight measure is the same as the disclosed SS-dimensional measure, with D_{SS}=1.

Further, it will be appreciated that, based on the disclosure heretofore including FIG. 8, a person skilled in the art will readily improve the accuracy of the item strength S_{G} determination by taking into consideration not only the md-W_{TR} associated with the “first level” taggers directly applying a given tag to an object, but also the md-W_{TR} associated with the “second level” taggers applying the given tag to the first level taggers, the md-W_{TR} associated with the “third level” taggers applying the given tag to the second level taggers . . . , and so on and so forth. Of course, the number of levels in one such recursive process is limited by the computational expensiveness of the process which entails recursive database queries for each tagger at each level, and for each item in a weighted list.

Finally, although server 100, as disclosed, is embodied in the form of various discrete functional blocks, such a server could equally well be embodied in an arrangement in which the functions of any one or more of those blocks or indeed, all of the functions thereof, are realized, for example, by one or more processors or devices.

What is claimed is:

1. An apparatus, comprising:
an interface for receiving an entry by a user of a given tag for an object; and
a processor configured to determine a plurality of weight measures associated with the entry by the user, a strength measure associated with the given tag for the object being determinable based at least on values of the weight measures, a weighted list being realizable wherein an item in the weighted list provides an indication of the strength measure.

2. The apparatus of claim 1 wherein the item represents the given tag, and the weighted list comprises a tag cloud.

3. The apparatus of claim 1 wherein the item represents the object, and the weighted list comprises an object cloud.

4. The apparatus of claim 1 wherein at least one of the weight measures is based on the number of times the given tag has been applied.

5. The apparatus of claim 4 wherein the at least one weight measure is based on the number of times the given tag has been applied to any objects.

6. The apparatus of claim 4 wherein the at least one weight measure is based on the number of times the given tag has been applied by the user to one or more objects other than the object.

7. The apparatus of claim 1 wherein at least one of the weight measures is based on an amount of time elapsed since the given tag was applied to the object.

8. The apparatus of claim 1 wherein at least one of the weight measures is based on a length of time between initial and last applications of the given tag to the object.

9. The apparatus of claim 1 wherein at least one of the weight measures is based on the number of same tags applied to the user and the object.

10. The apparatus of claim 1 wherein at least one of the weight measures is based on the number of social objects that the user and the object have in common.

11. The apparatus of claim 1 wherein at least one of the weight measures is based on a notable relationship between the user and the object.

12. The apparatus of claim 1 wherein at least one of the weight measures is based on at least one of (a) the number of tags semantically related to the tag which have been applied to the user, and (b) an extent of similarity of the tag to the semantically related tags.

13. The apparatus of claim 1 wherein at least one of the weight measures is based on at least one of (a) the number of tags semantically related to the tag which have been applied by the user to one or more objects other than the object, and (b) an extent of similarity of the tag to the semantically related tags.

14. The apparatus of claim 1 wherein the strength measure is determined by aggregating at least the values of the weight measures, which are adjustable depending on relevance of the weight measures.

15. A method for use in an apparatus, comprising:
receiving an entry by a user of a given tag for an object;
determining a plurality of weight measures associated with the entry by the user;
determining a strength measure associated with the given tag for the object based at least on values of the weight measures; and
showing a weighted list wherein an item in the weighted list provides an indication of the strength measure.

16. The method of claim 15 wherein at least one of the weight measures is based on the number of times the given tag has been applied.

17. The method of claim 16 wherein the at least one weight measure is based on the number of times the given tag has been applied to any objects.

18. The method of claim 16 wherein the at least one weight measure is based on the number of times the given tag has been applied by the user to one or more objects other than the object.

19. The method of claim 15 wherein at least one of the weight measures is based on an amount of time elapsed since the given tag was applied to the object.

20. The method of claim 15 wherein at least one of the weight measures is based on a length of time between initial and last applications of the given tag to the object.

21. The method of claim 15 wherein at least one of the weight measures is based on the number of same tags applied to the user and the object.

22. The method of claim 15 wherein at least one of the weight measures is based on the number of social objects that the user and the object have in common.

23. The method of claim 15 wherein at least one of the weight measures is based on a notable relationship between the user and the object.

24. The method of claim 15 wherein at least one of the weight measures is based on at least one of (a) the number of tags semantically related to the tag which have been applied to the user, and (b) an extent of similarity of the tag to the semantically related tags.

25. The method of claim 15 wherein at least one of the weight measures is based on at least one of (a) the number of tags semantically related to the tag which have been applied by the user to one or more objects other than the object, and (b) an extent of similarity of the tag to the semantically related tags.

26. The method of claim 15 wherein the strength measure is determined by aggregating at least the values of the weight measures, which are adjustable depending on relevance of the weight measures.
